(19) United States
(12) Patent Application Publication
(10) Pub. No.: US 2007/0069431 A1
(43) Pub. Date: Mar. 29, 2007

(54) Method of manufacturing a bumper cover for a motor vehicle

(76) Inventors: Gottfried Sailer, Schorndorf (DE); Peter Diehl, Kirchheim (DE); Rainer Englisch, Plochingen (DE); Sebastian Schneider, Esslingen (DE)

Correspondence Address: CLARK HILL, P.C., 500 WOODWARD AVENUE, SUITE 3500, DETROIT, MI, 48226, US

(21) Appl. No.: 11/540,332

(22) Filed: Sep. 29, 2006

(30) Foreign Application Priority Data
Sep. 29, 2005 (DE) 102005048220.1

(51) Int. Cl. B29C 43/00

(52) U.S. Cl. 264/500

(57) ABSTRACT

A method is provided of manufacturing a bumper cover for a motor vehicle. The bumper cover includes at least one vehicle-specific deformation. The method includes the steps of injection molding a bumper cover blank using a single injection mold tool, and forming the at least one vehicle-specific deformation in the bumper cover blank to form the bumper cover.

### CROSS-REFERENCE TO RELATED APPLICATION

This application claims priority to and all the benefits of German Patent Application serial number DE 10 2005 048 220.1, filed on Sep. 29, 2005 and entitled “Method For Manufacturing A Lining Part Variant For A Motor Vehicle, And Lining Part.”

### BACKGROUND OF THE INVENTION

1. Field of the Invention

The present invention relates to a body molding for a motor vehicle, and more particularly, to a bumper cover and a method of manufacturing a bumper cover having any of a plurality of vehicle-specific deformations.

2. Description of Related Art

Almost all vehicles include at least one body molding, such as a bumper cover, which is conventionally made of a plastics material, such as polypropylene or polyurethane. Bumper covers are typically one-piece in construction and often a variety of motor vehicles have bumper covers with identical external dimensions, shape and appearance, and the only difference being a vehicle-specific deformation of the bumper cover. The vehicle-specific deformation may, for example, be a groove, an edge, or an embossment formed in the bumper cover. The vehicle-specific deformation may then be painted or used to receive a trim element, such as a trim strip.

Typically, this type of bumper cover is manufactured using an injection-molding process. In order to manufacture a plurality of bumper covers with each bumper cover having a different vehicle-specific deformation, as described above, it is necessary to have a plurality of different tools or molds because each variation of the bumper cover having a different vehicle-specific deformation requires its own mold. The process for manufacturing the plurality of bumper covers is highly cost-intensive because each mold has to be specifically configured for one bumper cover and cannot generally be used for another bumper cover. In view of the fact that there are often a large number of variations of bumper covers, which moreover change and supersede one another relatively rapidly for a specific vehicle type, the molds can often only be used for a short period of time before they have to be replaced by a new mold.

Therefore, it is desirable to provide a method for manufacturing a bumper cover having any of a plurality of vehicle-specific deformations that is rapid, simple and cost-effective compared to manufacturing processes currently known in the art.

### SUMMARY OF THE INVENTION

According to one aspect of the invention, a method is provided of manufacturing a bumper cover for a motor vehicle. The bumper cover includes at least one vehicle-specific deformation. The method includes the steps of injection molding a bumper cover blank using a single injection mold tool, and forming the at least one vehicle-specific deformation in the bumper cover blank to form the bumper cover.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1a is a cross-sectional side view of a bumper cover blank;

FIG. 1b is a cross-sectional side view of a bumper cover having a vehicle-specific deformation manufactured according to the invention, with a trim strip mounted thereto;

FIG. 2a is a cross-sectional side view of the bumper cover blank; and

FIG. 2b is a cross-sectional side view of a bumper cover having a painted vehicle-specific deformation.

### DETAILED DESCRIPTION OF THE PREFERRED EMBODIMENTS

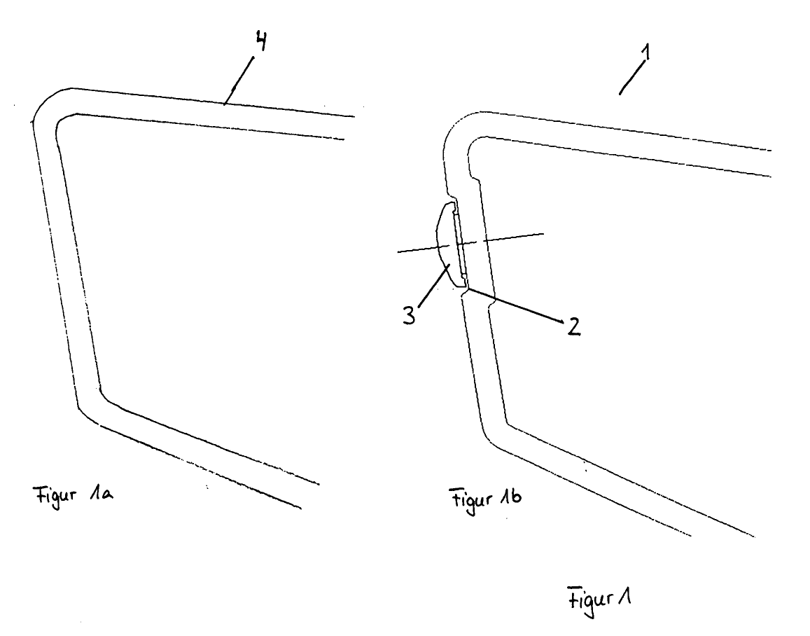

Referring to FIG. 1b, a bumper cover is generally shown at 1. The bumper cover 1 is configured as a rear bumper cover for a motor vehicle. The bumper cover 1 is formed having any of a plurality of vehicle-specific deformations 2, such as a groove, an edge, or an embossment. In the embodiment shown, the vehicle-specific deformation 2 is a groove. A trim strip 3 is fixedly secured to the bumper cover 1 along the groove 2. The groove 2 with the trim strip 3 fixedly secured thereto serves to distinguish the bumper cover 1 from any of a plurality of other bumper covers 1.

In order to keep the manufacture of the bumper covers 1 rapid, efficient and cost-effective, there is initially manufactured in a first step of the invention, a bumper cover blank 4, as shown in FIG. 1a. The dimensions, shape and size of the bumper cover blank 4 correspond to a common set of dimensions, shape and size of the plurality of bumper covers 1.

In a second step, the vehicle-specific deformation 2 is formed in the bumper cover blank 4 resulting in the manufacture of the bumper cover 1. Such vehicle-specific deformation 2 is crucial for the manufacture of different bumper covers 1. It will be appreciated that the manufacture of the bumper cover blank 4 is identical for all of the bumper covers 1, but the second step in which the vehicle-specific deformation 2 is formed, differs from part to part.

The bumper cover blank 4 is manufactured using a single tool. The bumper cover blank 4 is commonly manufactured using an injection-molding process and therefore requires the provision of an injection mold tool corresponding to the dimensions, shape and size of the bumper cover blank 4. In the case of the bumper cover blank 4 the injection mold tool to be used is relatively large and as a result, it is comparatively more cost-effective to manufacture only the bumper cover blank 4 using the injection-molding process and using the second step to form various vehicle-specific deformations 2 of the bumper cover 1. Typically, the bumper cover blank 4 is made from a plastics material, such as polypropylene or polyurethane, however any other material suitable for use with the injection-molding process may be used.

Next, the bumper cover blank 4 is subjected to the second step of the invention in which the vehicle-specific deformation 2 is formed. The vehicle-specific deformation 2 may vary in its configuration depending on the desired configuration of the bumper cover 1. Referring to FIG. 1b, the groove 2 formed in the bumper cover blank 4 is deep-drawn. The dimensions, precise shape and position of the vehicle-specific deformation 2 must be defined in a part to part or vehicle specific manner. The vehicle-specific deformation 2 may, for example, be formed by an embossing process in which a suitable male mold half and a suitable female mold half cooperate to form the vehicle-specific deformation 2 in the bumper cover blank 4. The plurality of possible bumper covers 1 will require various male and female mold halves; however, the provision of various male and female mold halves entails lower additional costs than having various injection mold tools for forming the vehicle-specific deformations 2. Depending on the dimensions, shape and size of the vehicle-specific deformation 2 to be formed in the bumper cover blank 4 provisions may be made to temporarily and locally heat the bumper cover blank 4 at suitable points in order to facilitate the embossing process.

Referring to FIG. 1b, the trim strip 3 fixedly secured along the groove 2 will distinguish between two of the same bumper covers 1. The trim strip 3 may be a metallic or metal-coated strip. The trim strip 3 may be fixedly secured along the groove 2 via a bonding means, such as a glue. In addition, the trim strip 3 may also be arranged in the groove 2 via a different type of connection, for example a clip connection or a screw connection. In order to produce a clip connection or a screw connection, there must be provided at suitable points along the groove 2, holes into which clips or screws may be introduced. Provision may be made for these holes to be punched simultaneously with the formation of the groove 2. If, for example, the groove 2 is formed using the male and female mold halves, as described above, provision may be made for either one of the male or female mold halves to have appropriate cutting projections capable of punching out suitably sized holes.

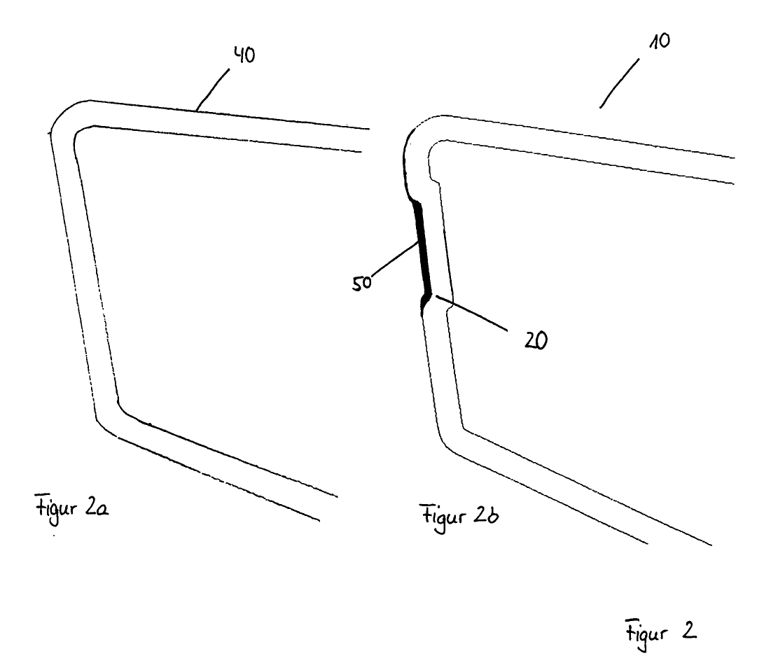

Referring to FIGS. 2a and 2b, in a second embodiment of the invention, according to a first step a bumper cover blank 40 is manufactured using an injection-molding process. In a second step, a vehicle-specific deformation, such as a groove 20 is formed in the bumper cover blank 40 resulting in the manufacture of a bumper cover 10. The groove 20 in the bumper cover 10 does not receive a trim strip 3 as shown in FIG. 1b, instead the groove 20 is painted with a paint 50 which can be any of a plurality of colors. It will be appreciated that the paint 50 can be the same color as the overall body of the motor vehicle. In addition, the color of the paint 50 can be used to distinguish between two of the same bumper covers 1.

The invention has been described here in an illustrative manner, and it is to be understood that the terminology used is intended to be in the nature of words or description rather than limitation. Many modifications and variations of the present invention are possible in light of the above teachings. It is, therefore, to be understood that within the scope of the appended claims, the invention may be practiced other than as specifically enumerated within the description.

What is claimed:

1. A method of manufacturing a bumper cover having at least one vehicle-specific deformation for a motor vehicle, the method comprising the steps of:
injection molding a bumper cover blank using a single injection mold tool;
removing the bumper cover blank from the single injection mold tool; and
forming the at least one vehicle-specific deformation in the bumper cover blank to form the bumper cover.

2. The method as set forth in claim 1, wherein the vehicle-specific deformation is deep-drawn using a male mold half and a female mold half cooperating therewith in an appropriate manner.

3. The method as set forth in claim 2, further including the step of attaching a trim element to the vehicle-specific deformation to complete the bumper cover.

4. The method as set forth in claim 3, wherein the step of forming at least one vehicle-specific deformation in the bumper cover blank includes the step of punching holes in the at least one vehicle-specific deformation for receiving connectors to fixedly secure the trim element thereto.

5. The method as set forth in claim 4, wherein the step of punching holes in the at least one vehicle-specific deformation is performed after the step of forming at least one vehicle-specific deformation in the bumper cover blank.

6. The method as set forth in claim 3, further including the step of gluing the trim element to the at least one vehicle-specific deformation.

7. The method as set forth in claim 2, further including the step of painting the at least one vehicle-specific deformation in any of a plurality of colors.
